(19) United States
(12) Patent Application Publication
(10) Pub. No.: US 2005/0146597 A1
(43) Pub. Date: Jul. 7, 2005

(54) Image recording apparatus and light-quantity correcting method

(75) Inventor: Yasuhiro Seto, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/951,728

(22) Filed: Sep. 29, 2004

(30) Foreign Application Priority Data
Sep. 29, 2003 (JP) (PAT)337716/2003

(51) Int. Cl. B41J 2/435

(52) U.S. Cl. 347/246

(57) ABSTRACT

An image recording apparatus for recording a gradation image on a photosensitive material has a light-emitting element array in which a plurality of light-emitting elements are arranged in a horizontal scanning direction, vertical scanning means for moving the light-emitting element array and the photosensitive material relatively in a vertical scanning direction, and a drive unit for controlling light-emitting time of each light-emitting element according to image data representing the gradation image. A deviation in light quantity between the light-emitting elements is calculated when the light-emitting elements are caused to emit light in a steady state. After the deviation in light quantity is corrected, a deviation in response characteristic between the light-emitting elements is calculated when the light-emitting elements are caused to emit light in pulsed form before they reach the steady state. The deviation in light quantity and the deviation in response characteristic are corrected when recording the gradation image.

### BACKGROUND OF THE INVENTION

1. Field of the Invention

The present invention relates to an image recording apparatus for exposing a photosensitive material with a light-emitting element array. The invention also relates to a method of correcting a deviation in exposure between the light-emitting elements of the light-emitting element array in the image recording apparatus.

2. Description of the Related Art

There is a conventional image recording apparatus for forming a gradation image represented by image data on a photosensitive material. The recording apparatus is equipped with a light-emitting element array, vertical scanning means, and a drive circuit. The light-emitting element array consists of a plurality of light-emitting elements arranged in a horizontal scanning direction. The vertical scanning means is used to move the light-emitting element array and the photosensitive material relatively in a vertical scanning direction approximately perpendicular to the horizontal scanning direction. The drive circuit controls the light-emitting time (pulse width) of each of the light-emitting elements according to the image data representing the gradation image. Such a recording apparatus is disclosed in U.S. Patent Laid-Open No. 20010052926 by way of example.

As the light-emitting element, a semiconductor laser, alight-emitting diode (LED), anorganic electroluminescent (EL) element, etc., are widely used. However, if there is a difference in light-emitting characteristics between such light-emitting elements, a difference occurs in an exposure that a photosensitive material undergoes, when the light-emitting elements are driven according to the same image data. Therefore, when such a difference in light-emitting characteristics is present between adjacent light-emitting elements, a difference in density occurs in a recorded image in a horizontal scanning direction, and consequently, linear unevenness of density (striped blurs) extends in a vertical scanning direction perpendicular to the horizontal scanning direction.

Hence, there has been proposed a first method in which the light-emitting elements are continuously caused to emit light until they reach a steady state, then a deviation in light quantity between the light-emitting elements is calculated, and the deviation in light quantity is corrected by adjusting a current for driving the light-emitting element according to that deviation when recording an image.

However, since the above-described correction method cannot correct a deviation in response characteristics (transient characteristics at startup time) between light-emitting elements, a second method of correcting the deviation in response characteristic has been proposed, for example, in Japanese Unexamined Patent Publication No. 6(1994)-234239. That is, in an apparatus for recording a gradation image by modulating the light intensity of each of the light-emitting elements of a light-emitting element array according to image data, the light-emitting elements are caused to emit light in a steady state. At this time, a deviation in light quantity between the light-emitting elements is calculated. After that deviation is corrected, each of the light-emitting elements is caused to emit light under actual printing conditions. At this time, a deviation in response characteristic between the light-emitting elements is calculated. The deviation in light quantity and the deviation in response characteristic are corrected when recording an image.

Furthermore, Japanese Unexamined Patent Publication No. 2002-72364 discloses a third light-quantity correcting method. In an image recording apparatus employing a light-emitting element array that consists of a plurality of light-emitting elements, the light-emitting elements are caused to emit light according to gradation data, respectively. For each gradation, a deviation in exposure between the light-emitting elements is calculated. When recording an image, the deviation in exposure is corrected.

In the first light-quantity correcting method, as set forth in Japanese Unexamined Patent Publication No. 6(1994)-234239, a deviation in response characteristic between light-emitting elements cannot be corrected.

In the second light-quantity correcting method shown in Japanese Unexamined Patent Publication No. 6(1994)-234239, when calculating a deviation in response characteristic between light-emitting elements on the assumption that the intensity of recording light is modulated, the light-emitting elements are caused to emit light under actual printing conditions. However, in the case where such a light-quantity correcting method is applied to an image recording apparatus that controls the light-emitting time (pulse width) of each light-emitting element, there is a possibility that depending on actual printing conditions, a deviation in response characteristic will not be accurately corrected. Accurate correction requires the measurement and correction of a deviation to be performed for each of all pulse widths. Such an operation is extremely troublesome, so the correction of a light quantity is time-consuming and costly.

In the light-quantity correcting method shown in Japanese Unexamined Patent publication No. 2002-72364, a deviation in exposure between light-emitting elements is calculated every a plurality of gradations. As mentioned in the embodiment of Japanese Unexamined Patent Publication No. 2002-72364, the method requires a minimum of about 4 gradations. Therefore, in this method, the deviation measurement and correction are likewise time-consuming and costly.

### SUMMARY OF THE INVENTION

The present invention has been developed in view of the above-described problems. Accordingly, it is an object of the present invention to provide a light-quantity correcting method that is capable of preventing the aforementioned striped blurs without requiring a considerable time and cost, in an image recording apparatus that controls the light-emitting time of each light-emitting element and records a gradation image. Another object is to provide an image recording apparatus which is capable of carrying out such a light-quantity correcting method.

To achieve the aforementioned objects of the present invention, there is provided a light-quantity correcting method, which is used in an image recording apparatus for recording a gradation image on a photosensitive material. The image recording apparatus includes a light-emitting element array in which a plurality of light-emitting elements are arranged in a horizontal scanning direction; vertical scanning means for moving the light-emitting element array and the photosensitive material relatively in a vertical scanning direction approximately perpendicular to the horizontal scanning direction; and drive means for controlling light-emitting time of each of the plurality of light-emitting elements according to image data representing the gradation image. In the light-quantity correcting method, a deviation in light quantity between the light-emitting elements is calculated when the light-emitting elements are caused to emit light in a steady state. After the deviation in light quantity is corrected, a deviation in response characteristic between the light-emitting elements is calculated when the light-emitting elements are caused to emit light in pulsed form before they reach the steady state. The deviation in light quantity and the deviation in response characteristic are corrected when recording the gradation image.

In accordance with the present invention, there is provided an image recording apparatus for recording a gradation image on a photosensitive material. The apparatus includes a light-emitting element array in which a plurality of light-emitting elements are arranged in a horizontal scanning direction; vertical scanning means for moving the light-emitting element array and the photosensitive material relatively in a vertical scanning direction approximately perpendicular to the horizontal scanning direction; and drive means for controlling light-emitting time of each of the plurality of light-emitting elements according to image data representing the gradation image. The image recording apparatus further includes light-quantity-deviation calculation means for calculating a deviation in light quantity between the light-emitting elements when the light-emitting elements are caused to emit light in a steady state; response-deviation calculation means for calculating a deviation in response characteristic between the light-emitting elements when the light-emitting elements are caused to emit light in pulsed form before they reach the steady state, after the deviation in light quantity is corrected; and correction means for correcting the deviation in light quantity and the deviation in response characteristic when recording the gradation image.

In the light-quantity correcting method of the present invention, the deviation in response characteristic is preferably calculated according to an exposure amount, exposed by each of the light-emitting elements when the light-emitting elements are caused to emit light in pulsed form for a predetermined time close to response time of a light-emitting element of the light-emitting elements which is slowest in response time. In that case, the exposure is preferably calculated by integrating the light intensity of each light-emitting element in light-emitting time.

The aforementioned deviation in light quantity is preferably calculated according to light intensities of the plurality of light-emitting elements.

The aforementioned deviation in light quantity is preferably corrected by multiplying at least either one of a drive voltage, drive current, or light-emitting time of each light-emitting element by a correction coefficient. In this case, the light-emitting element and the correction coefficient are preferably stored in a look-up table so that they correspond to each other, and the multiplication is performed by employing the correction coefficient read out from the look-up table, for each of the light-emitting elements.

On the other hand, the aforementioned deviation in response characteristic is preferably corrected by adding a correction value to at least either one of a drive voltage, drive current, or light-emitting time of each light-emitting element. In that case, it is preferable that the light-emitting element and the correction value be stored in a look-up table so that they correspond to each other, and it is also preferable that the addition be performed by employing the correction value read out from the look-up table, for each of the light-emitting elements.

According to the light-quantity correcting method of the present invention, a deviation in light quantity between the light-emitting elements is calculated when the light-emitting elements are caused to emit light in a steady state. After the deviation in light quantity is corrected, a deviation in response characteristic between the light-emitting elements is calculated when the light-emitting elements are caused to emit light in pulsed form before they reach the steady state. The deviation in light quantity and the deviation in response characteristic are corrected when recording the gradation image. Thus, since both the deviation in light quantity and the deviation in response characteristic are corrected, the aforementioned striped blurs can be prevented.

In the method of the present invention, measurements of a deviation are made only twice. That is, the two measurements are a measurement of a deviation in light quantity that is made with light-emitting elements on in a steady state, and a measurement of a deviation in response characteristic that is made with the light-emitting elements on in pulsed form before they reach a steady state. Thus, this method makes it possible to reduce the time and cost required for light-quantity correction.

The measurement and correction of a deviation in light quantity and a deviation in response characteristic may be made as appropriate, depending on how the image recording apparatus is used. For instance, when shipping the image recording apparatus from a factory, the deviation measurement and correction may be performed. When the image recording apparatus is actually being used by a user, the deviation measurement and correction may be periodically performed once a day, a week, or a month. Furthermore, the deviation measurement and correction may be performed each time the image recording apparatus is switched on. Particularly, if the deviation measurement and correction are carried out as the image recording apparatus is actually used, the image recording apparatus of the present invention is able to cope with temporal changes in the light-emitting characteristic of each light-emitting element.

### BRIEF DESCRIPTION OF THE DRAWINGS

The present invention will be described in further detail with reference to the accompanying drawings wherein:

FIG. 1 is a side view showing an image recording apparatus constructed in accordance with a preferred embodiment of the present invention;

FIG. 2 is a schematic plan view showing the exposure head of the image recording apparatus shown in FIG. 1;

FIG. 3 is a schematic diagram showing how the red EL elements of the exposure head are arranged;

FIG. 4 is a schematic diagram showing how the green EL elements of the exposure head are arranged;

FIG. 5 is a schematic diagram showing how the blue EL elements of the exposure head are arranged;

FIG. 6 is a block diagram showing the EL-element drive circuit of the image recording apparatus shown in FIG. 1;

FIG. 7A to 7J are waveform diagrams showing a signal waveform in the EL-element drive circuit shown in FIG. 6;

FIG. 8 is a block diagram showing an apparatus that carries out a light-quantity correcting method of the preferred embodiment of the present invention;

FIG. 9 is a schematic diagram showing the light-emitting characteristic of the organic EL element;

FIG. 10 is a schematic diagram showing the modulation characteristic of the organic EL element in which light-quantity correction has not been made;

FIG. 11 is a schematic diagram showing the modulation characteristic of the organic EL element in which a deviation in light quantity has been corrected;

FIG. 12 is a schematic diagram showing the modulation characteristic of the organic EL element in which a deviation in light quantity and a deviation in response characteristic have been corrected;

FIG. 13 is an enlarged view showing the modulation characteristic of FIG. 12; and

FIGS. 14A and 14B are schematic diagrams showing the sensitometric characteristic of a photosensitive material.

### DESCRIPTION OF THE PREFERRED EMBODIMENTS

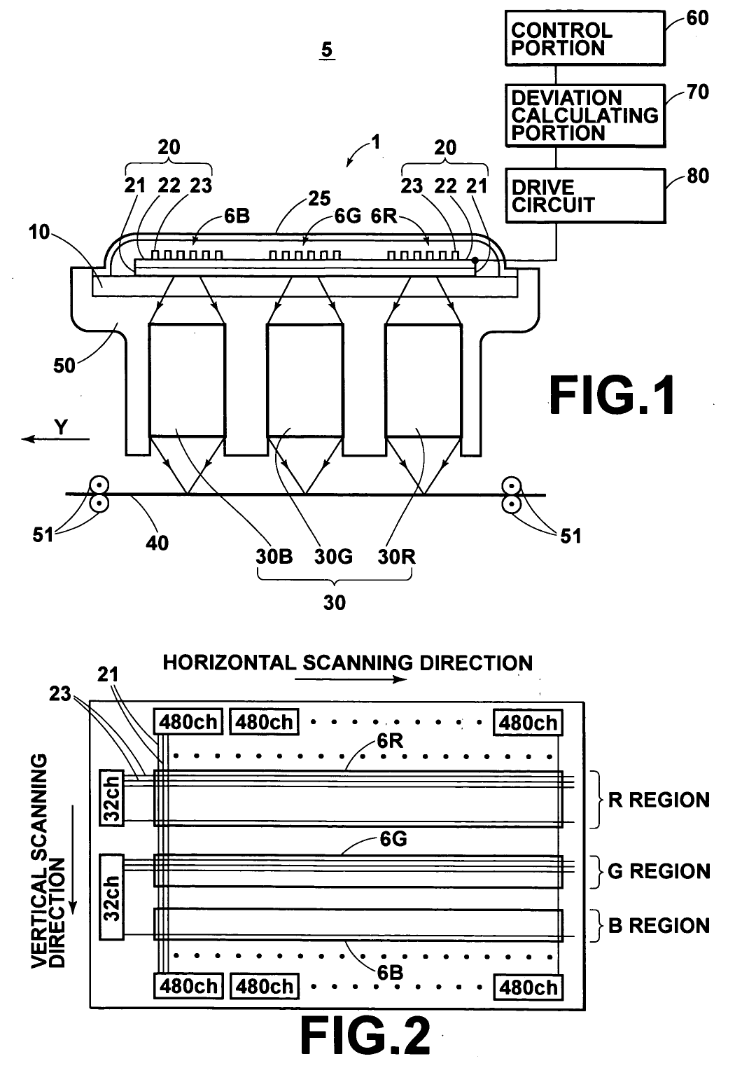

Referring now in greater detail to the drawings and initially to FIG. 1, there is shown an image recording apparatus 5 that carries out a light-quantity correcting method of a preferred embodiment of the present invention. As shown in the Figure, the image recording apparatus 5 includes an exposure head 1. The exposure head 1 is made up of a transparent substrate 10; a great number of organic electroluminescent (EL) elements 20 formed on the transparent substrate 10 by vapor deposition; a refractive index profile type lens array 30 (30R, 30G, and 30B) as a 1:1 optical image-forming system for forming images on a color photosensitive material 40 by light emitted from the EL elements 20; and a support 50 for supporting the transparent substrate 10 and refractive index profile type lens array 30.

The image recording apparatus 5 includes vertical scanning means 51 consisting of nip rollers, etc., in addition to the exposure head 1. The vertical scanning means 51 is used to convey the color photosensitive material 40 at a uniform speed in a vertical scanning direction indicated by an arrow Y.

Each of the organic EL elements 20 consists of a transparent positive electrode 21, an organic compound layer 22 including an EL layer and formed in the unit of one pixel, and a metal negative electrode 23. The transparent positive electrode 21, the organic compound layer 22, and the metal negative electrode are stacked on the transparent substrate 10 (consisting of glass, etc.) in the recited order by vapor deposition. And the organic EL elements 20 are disposed within a sealing member 25 consisting of a stainless can, etc. More specifically, the margin of the sealing member 25 and the transparent substrate 10 are bonded together, and the sealing member 25 is filled with dried nitrogen gas, and the organic EL elements 20 are sealed within the sealing member 25.

In the organic EL element 20, if a predetermined voltage is applied between the transparent positive electrode 21 and the metal negative electrode 23, the EL layer contained in the organic compound layer 22 emits light. The emitted light is taken out through the transparent positive electrode 21 and transparent substrate 10. Note that the organic EL element 20 has the property of stabilizing wavelength. How the organic EL elements 20 are arranged will be described in detail later.

It is preferable that the transparent positive electrode 21 have a transmittance of at least 50% or greater, preferably 70% or greater, in a visible wavelength region of 400 to 700 nm. The material of the transparent positive electrode 21 can employ conventional compounds known as transparent positive electrodes, such as tin oxide, indium tin oxide (ITO), indium zinc oxide, etc. In addition to these, it may employ a thin film consisting of metal whose work function is great, such as gold, white gold, etc. It can also employ organic compounds such as polyaniline, polytiophene, polypyrrole, or a derivate of these. It is also possible to apply transparent conductive films, described in “New Development of Transparent Conductive Films” (Yutaka Sawada, Ed., CMC, 1999), to the present invention. The transparent positive electrode 21 can be formed on the transparent substrate 10 by vacuum deposition, sputtering, ion plating, etc.

On the other hand, the organic compound layer 22 may be a single layer consisting of an EL layer alone. It may also be a multilayer. That is, the organic compound layer 22, in addition to the EL layer, may include other layers such as a hole injection layer, a hole transport layer, an electron injection layer, an electron transport layer, etc. Examples are (1) an EL element consisting of a positive electrode, a hole injection layer, a hole transport layer, an EL layer, an electron transport layer, and a negative layer; (2) an EL element consisting of a positive electrode, an EL layer, an electron transport layer, and a negative electrode; (3) an EL element consisting of a positive electrode, a hole transport layer, an EL layer, an electron transport layer, and a negative electrode; and so forth. In addition, each of the EL, hole transport, hole injection, and electron injection layers may consist of a plurality of layers.

The metal negative electrode 23 is preferably formed from a metal material such as (1) alkali metal such as Li and K whose work function is low, (2) alkali earth metal such as Mg and Ca, and (3) an alloy or mixture of these metals and Ag or Al. To ensure compatibility between the storage stability and electron injection in the negative electrode, an electrode formed from the above-described materials may further be coated with Ag, Al, or Au where the work function is great and the conductivity is high. The metal negative electrode 23, as with the transparent positive electrode 21, can be formed by vacuum deposition, sputtering, ion plating, etc.

Next, a detailed description will be given of how the organic EL elements 20 are arrayed. FIG. 2 shows how the transparent positive electrodes 21 and metal negative electrodes 23 of the exposure head 1 are arrayed. As the Figure shows, a vertical linear array of transparent positive electrodes 21 extends lengthwise in approximately the vertical scanning direction, and the linear positive electrode array is used as the common electrode of the organic EL elements 20 arranged in that direction. In the preferred embodiment, 480×8 linear positive electrode arrays (i.e., 3840 linear positive electrode arrays) are arranged in a horizontal scanning direction perpendicular to the vertical scanning direction. On the other hand, a horizontal linear array of metal negative electrodes 23 extends lengthwise in the horizontal scanning direction, and it is used as the common electrode of the organic EL elements 20 arranged in that direction. In the preferred embodiment, 64 linear negative electrode arrays are arranged in the vertical scanning direction.

The transparent positive electrodes 21 and metal negative electrodes 23 are used as column electrodes and row electrodes, respectively. If a predetermined voltage is applied between the transparent positive electrode 21 and metal negative electrode 23, selected according to image data by a drive circuit 80 shown in FIG. 1, the EL layer contained in the organic compound layer 22, arranged at a point where that transparent positive electrode 21 and that metal negative electrode 23 cross each other, emits light. The emitted light is taken out from the transparent substrate 10. That is, in the preferred embodiment, the organic EL elements 20 are formed at points where the transparent positive electrodes 21 and metal negative electrodes 23 cross, respectively. And the organic EL elements 20 are arranged at intervals of a predetermined pitch in the horizontal scanning direction and constitute linear EL element arrays. The linear EL element arrays are arranged in the vertical scanning direction and constitute a planar EL element array.

As set forth above, the preferred embodiment adopts the passive matrix drive system, which will be described in detail later. Also, a control section 60 and deviation calculating portion 70 of the first and second stages of the image recording apparatus will be described in detail later. In addition to the passive matrix drive system, the present invention may adopt an active matrix drive system that employs switching devices such as thin film transistors (TFTs), etc.

The exposure head 1 in the preferred embodiment is constructed so a full-color image can be formed on the color photosensitive material 40 such as a silver halide color paper, etc. For that reason, the exposure head 1 is constructed as described below.

The organic EL elements 20 consist of red EL elements 20R, green EL elements 20G, and blue EL elements 20B. The EL layer contained in the organic compound layer 22 of the red EL element 20R emits red light by the application of a voltage. Similarly, the EL layer contained in the organic compound layer 22 of the green EL element 20G emits green light, and the EL layer contained in the organic compound layer 22 of the blue EL element 20B emits blue light.

The red EL elements 20R are arrayed in the R region shown in FIG. 2. That is, 3840 red EL elements 20R arrayed in the horizontal scanning direction constitute one linear red EL element array. In addition, 32 linear red EL element arrays are arranged in the vertical scanning direction and constitute a planar red EL element array 6R.

The green EL elements 20G are arrayed in the G region shown in FIG. 2. That is, 3840 green EL elements 20G arrayed in the horizontal scanning direction constitute one linear green EL element array. In addition, 16 linear green EL element arrays are arranged in the vertical scanning direction and constitute a planar green EL element array 6G.

The blue EL elements 20B are arrayed in the B region shown in FIG. 2. That is, 3840 blue EL elements 20B arrayed in the horizontal scanning direction constitute one linear blue EL element array. In addition, 16 linear blue EL element arrays are arranged in the vertical scanning direction and constitute a planar blue EL element array 6G.

Note that in FIG. 1, the linear EL element arrays, which constitute the planar red EL element array 6R, planar green EL element array 6G, and planar blue EL element array 6B, are shown as 6 rows, respectively, for convenience.

When forming a full-color image on the color photosensitive material 40 by the image recording apparatus 5 shown in FIG. 1, the planar red EL element array 6R, planar green EL element array 6G, and planar blue EL element array 6B of the exposure head 1 are driven according to red image data, green image data, and blue image data by the drive circuit 80, respectively. At the same time, the color photosensitive material 40 is conveyed at a constant speed in the vertical scanning direction indicated by an arrow Y by the vertical scanning means 51.

At this time, an image by the red light from the 32 linear red EL element arrays of the planar red EL element array 6R, an image by the green light from the 16 linear green EL element arrays of the planar green EL element array 6G, and an image by the blue light from the 16 linear blue EL element arrays of the planar blue EL element array 6B, are formed on the color photosensitive material 40 in a 1:1 ratio by the refractive index profile type lens arrays 30R, 30G, and 30B, respectively. That is, the portion exposed with the red light from the 32 linear red EL element arrays is then exposed with the green light from the 16 linear green EL element arrays and is further exposed with the blue light from the 16 linear blue EL element arrays. And the full-color horizontal scanning lines thus formed are formed sequentially in the vertical scanning direction as the color photosensitive material 40 is conveyed. In this manner, a two-dimensional full-color image is formed on the color photosensitive material 40.

The refractive index profile type lens array 30R may be constructed of SELFOC lenses (registered trademark) arrayed so as to respectively correspond to the red EL elements 20R. Likewise, the refractive index profile type lens arrays 30G and 30B may be constructed.

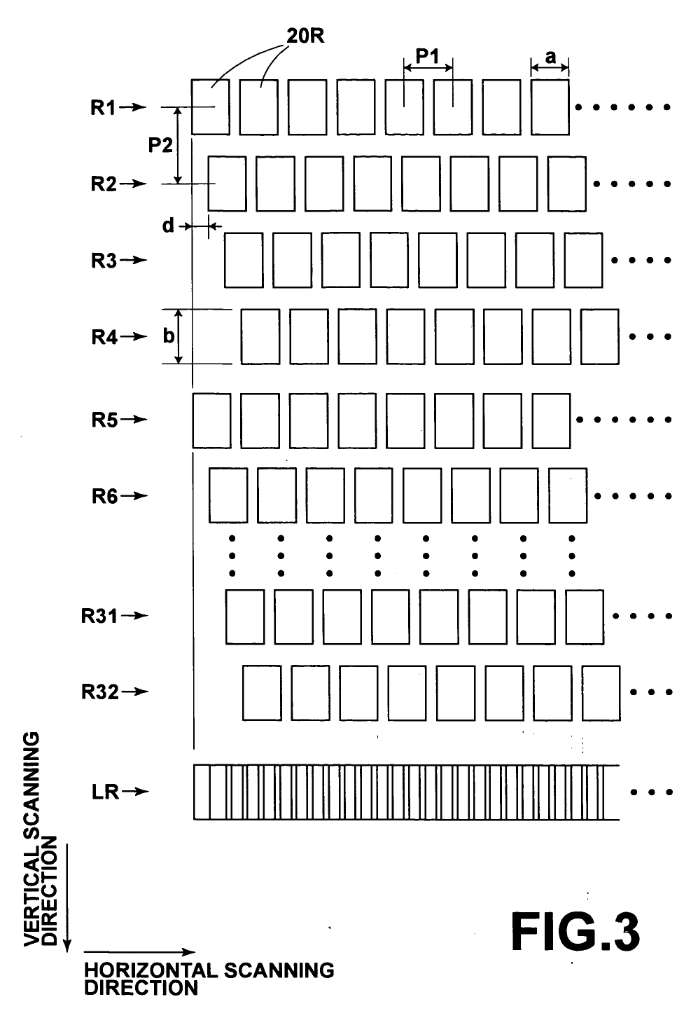

Next, the planar EL element arrays 6R, 6G, and 6B will be described in further detail. FIG. 3 shows how the planar red EL element array 6R is arranged. As shown in the Figure, the 32 linear red EL element arrays R1 to R32 of the planar red EL element array 6R are arranged in sequence in the vertical scanning direction. Each red EL element 20R of the linear red EL element arrays R1 to R32 has a size of a in the horizontal scanning direction and a size of b in the vertical scanning direction. The pitches in the horizontal and vertical scanning directions are P1 and P2, respectively.

In addition, the linear red EL element arrays R2, R3, and R4 are arranged so that they are shifted from the first linear red EL element array R1 by predetermined distances of d, 2d, and 3d in the horizontal scanning direction, respectively. And the fifth linear red EL element array R5 is arranged so it coincides with the first linear red EL element array R1 in the vertical scanning direction. That is, the above-described arrangement with the shifts in the horizontal scanning direction is repeated every four linear red EL element arrays. Therefore, the horizontal scanning line LR on the color photosensitive material 40, which is exposed with red light, consists of a plurality of pixels arranged at pitches of ¼ of the horizontal pitch P1 of the red EL elements 20R.

As set forth above, the first pixel of the horizontal scanning line LR is exposed with the first red EL element 20R of each of the linear red EL element arrays R1, R5, R9, R13, R17, R21, R25, and R29. The second pixel is exposed with the first red EL element 20R of each of the linear red EL element arrays R2, R6, R10, R14, R18, R22, R26, and R30. The third pixel is exposed with the first red EL element 20R of each of the linear red EL element arrays R3, R7, R11, R15, R19, R23, R27, and R31. The fourth pixel is exposed with the first red EL element 20R of each of the linear red EL element arrays R4, R8, R12, R16, R20, R24, R28, and R32. The fifth pixel is exposed with the second red EL element 20R of each of the linear red EL element arrays R1, R5, R9, R13, R17, R21, R25, and R29. In like manner, one pixel of the horizontal scanning line LR is exposed with 8 red EL elements 20R. And the 8 red EL elements 20R are caused to emit light in pulse form, and by controlling the pulse width, gradations are obtained for each pixel, so that a continuous gradation image can be formed on the color photosensitive material.

The exposure that the color photosensitive material 40 undergoes from the red EL element 20R becomes greatest at a first portion corresponding to the center of the red EL element 20R and becomes less at a second portion corresponding to the edge portion of the red EL element 20R than at the first portion. Therefore, if one horizontal scanning line is exposed with one linear red EL element array, the exposure along the horizontal scanning direction significantly ripples according to the pitch of the red EL elements 20R. When the exposure ripple is significant, there is a possibility that unevenness of exposure will occur in the horizontal scanning direction.

To cope with this problem, the linear red EL element arrays in the preferred embodiment are arranged so the red EL elements 20R overlap partially in the horizontal scanning direction. That is, in one horizontal scanning line that is multiply exposed by a plurality of linear red EL element arrays, an exposure ripple characteristic due to a linear red EL element array is shifted from another exposure ripple characteristic due to the adjacent linear EL element in the horizontal scanning direction, and they overlap each other. Therefore, a portion that undergoes less exposure from a linear red EL element array undergoes more exposure from the adjacent linear red EL element array. Hence, exposure ripples offset each other, so exposure unevenness in the horizontal scanning direction can be prevented.

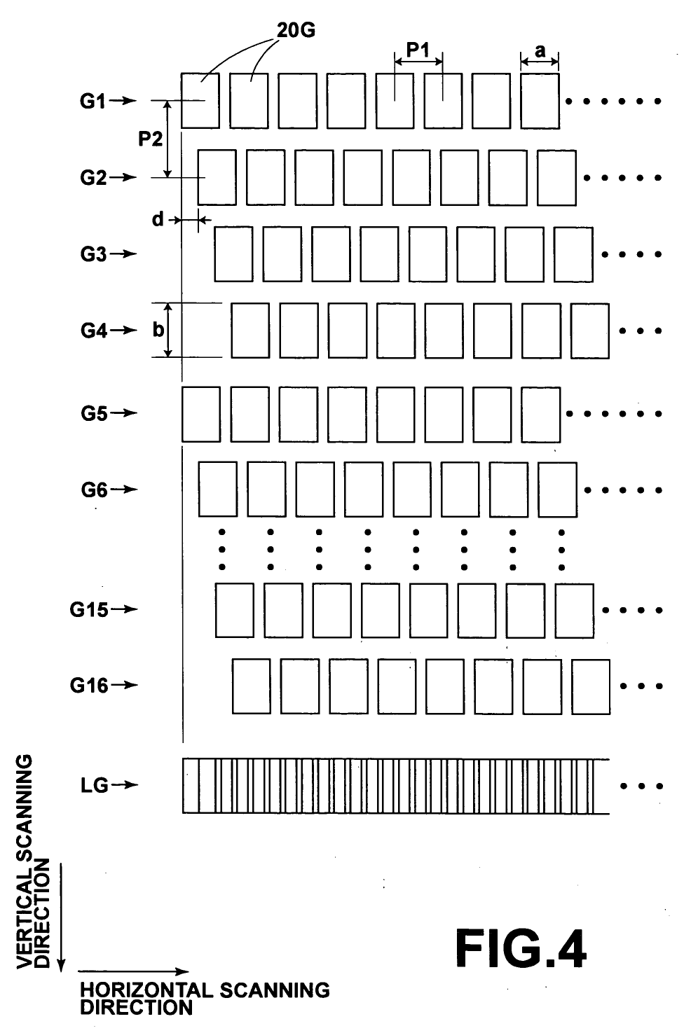

FIG. 4 shows how the planar green EL element array 6G is arranged. As the Figure shows, the 16 linear green EL element arrays G1 to G16 of the planar green EL element array 6G are arranged in sequence in the vertical scanning direction. Each green EL element 20G of the linear green EL element arrays G1 to G16 has a size of a in the horizontal scanning direction and a size of b in the vertical scanning direction. The pitches in the horizontal and vertical scanning directions are P1 and P2, respectively. Thus, the element sizes and pitches are the same as those of the planar red EL element array 6R.

In addition, the linear green EL element arrays G2, G3, and G4 are arranged so they are shifted from the first linear green EL element array G1 by predetermined distances of d, 2d, and 3d in the horizontal scanning direction, respectively. And the fifth linear green EL element array G5 is arranged so it coincides with the first linear green EL element array G1 in the vertical scanning direction. That is, the above-described arrangement with the shifts in the horizontal scanning direction is repeated every four linear green EL element arrays. Therefore, the horizontal scanning line LG on the color photosensitive material 40, which is exposed with green light, consists of a plurality of pixels arranged at pitches of ¼ of the horizontal pitch P1 of the green EL elements 20G.

As set forth above, the first pixel of the horizontal scanning line LG is exposed with the first green EL element 20G of each of the linear green EL element arrays G1, G5, G9, and G13. The second pixel is exposed with the first green EL element 20G of each of the linear green EL element arrays G2, G6, G10, and G14. The third pixel is exposed with the first green EL element 20G of each of the linear green EL element arrays G3, G7, G11, and G15. The fourth pixel is exposed with the first green EL element 20G of each of the linear green EL element arrays G4, G8, G12, and G16. The fifth pixel is exposed with the second green EL element 20G of each of the linear green EL element arrays G1, G5, G9, and G13. In like manner, one pixel of the horizontal scanning line LG is exposed with 4 green EL elements 20G.

In the planar green EL element array 6G, the driving of green EL elements 20G to obtain gradations for each pixel, and the suppression of the exposure ripples in the horizontal scanning direction are performed in the same manner as the planar red EL element array 6R.

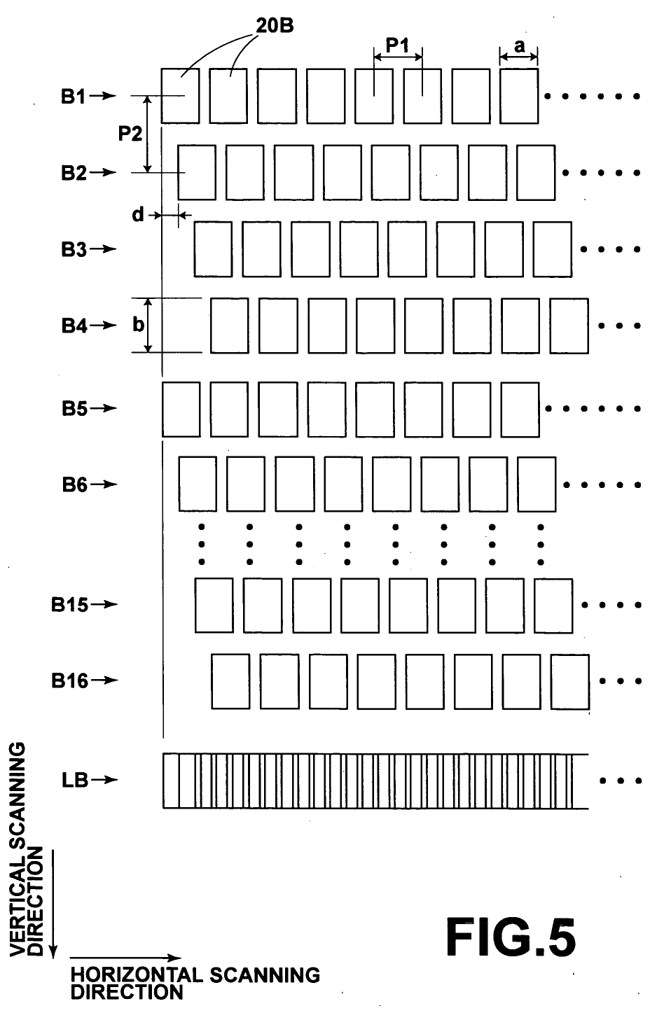

FIG. 5 shows how the planar blue EL element array 6B is arranged. As the Figure shows, the 16 linear blue EL element arrays B1 to B16 of the planar green EL element array 6B are arranged in sequence in the vertical scanning direction. Each blue EL element 20B of the linear blue EL element arrays B1 to B16 has a size of a in the horizontal scanning direction and a size of b in the vertical scanning direction. The pitches in the horizontal and vertical scanning directions are P1 and P2, respectively. Thus, the element sizes and pitches are the same as those of the planar red EL element array 6R and planar green EL element array 6G.

In addition, the linear blue EL element arrays B2, B3, and B4 are arranged so they are shifted from the first linear blue EL element array B1 by predetermined distances of d, 2d, and 3d in the horizontal scanning direction, respectively. And the fifth linear blue EL element array B5 is arranged so it coincides with the first linear blue EL element array B1 in the vertical scanning direction. That is, the above-described arrangement with the shifts in the horizontal scanning direction is repeated every four linear blue EL element arrays. Therefore, the horizontal scanning line LB on the color photosensitive material 40, which is exposed with blue light, consists of a plurality of pixels arranged at pitches of ¼ of the horizontal pitch P1 of the blue EL elements 20B.

As set forth above, the first pixel of the horizontal scanning line LB is exposed with the first blue EL element 20B of each of the linear blue EL element arrays B1, B5, B9, and B13. The second pixel is exposed with the first blue EL element 20B of each of the linear blue EL element arrays B2, B6, B10, and B14. The third pixel is exposed with the first blue EL element 20B of each of the linear blue EL element arrays B3, B7, B11, and B15. The fourth pixel is exposed with the first blue EL element 20B of each of the linear blue EL element arrays B4, B8, B12, and B16. The fifth pixel is exposed with the second blue EL element 20B of each of the linear blue EL element arrays B1, B5, B9, and B13. In like manner, one pixel of the horizontal scanning line LB is exposed with 4 blue EL elements 20B.

In the planar blue EL element array 6B, the driving of blue EL elements 20B to obtain gradations for each pixel, and the suppression of the exposure ripples in the horizontal scanning direction are performed in the same manner as the planar red EL element array 6R.

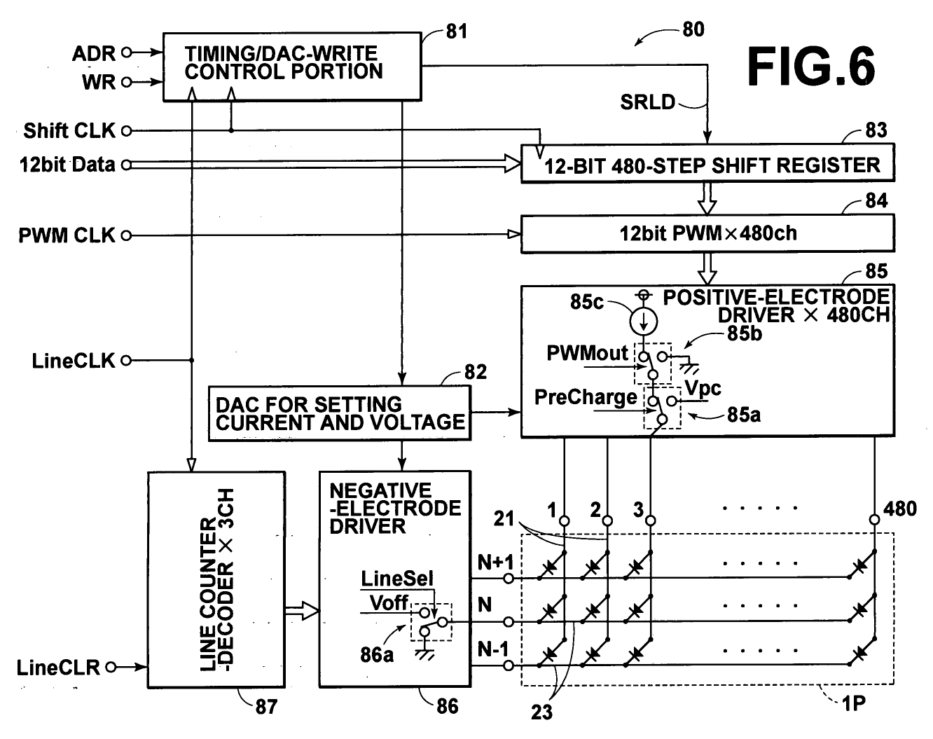

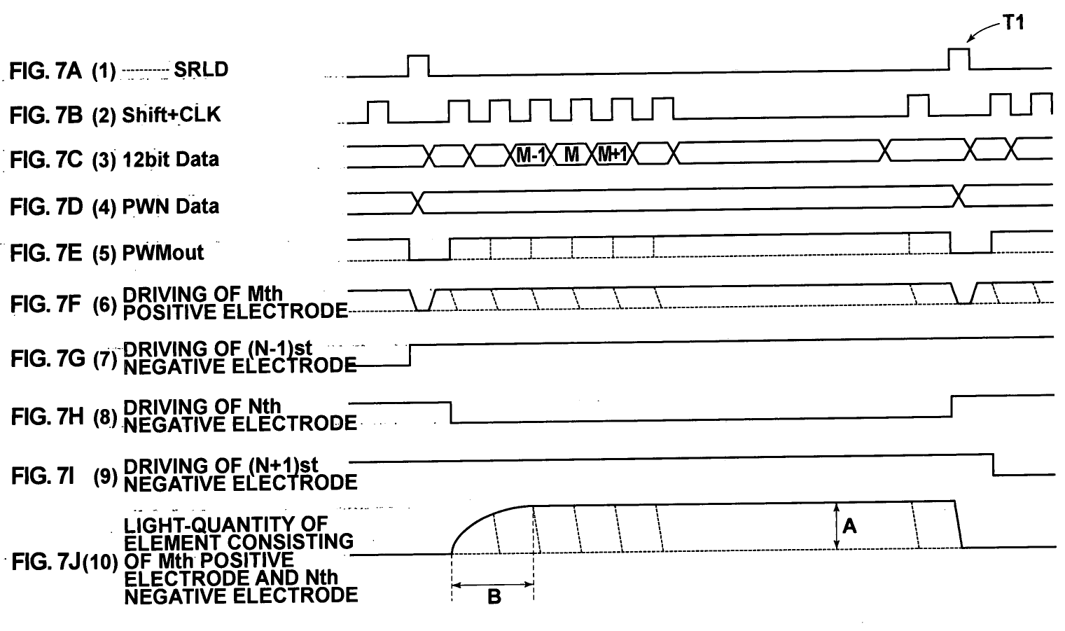

How the exposure head 1 is driven by the drive circuit 80 will be described in further detail with reference to FIGS. 6 and 7. The construction of the drive circuit 80 is shown in FIG. 6, and the waveforms of various signals in the drive circuit 80 are shown in FIGS. 7A to 7I. The light-emitting characteristic of the organic EL element 20 corresponding to the signal waveforms is shown in FIG. 7J. In FIG. 6, reference character 1P denotes an organic EL panel that constitutes the exposure head 1, and other sections denote the components of the drive circuit 80. Also, the organic EL panel 1P consists of 480 transparent positive electrodes 21, and three ((N−1)^{th}, N^{th}, and (N+1)^{th}) metal negative electrodes 23, for convenience. The following explanation will be given according to this construction.

A DAC selection signal ADR, a DAC write signal WR, a shift clock SHIFT CLK, and a line clock LINE CLK are input to the timing/DAC-write control portion 81 of the drive circuit 80. In response to these signals, the control portion 81 controls a digital-to-analog converter (DAC) 82 for setting current and voltage and a shift register 83. A serial load signal SRLD from the control portion 81, synchronized with the line clock LINE CLK, is input to the shift register 83. The shift clock SHIFT CLK and 12-bit image data DATA are also input to the shift register 83.

The image data DATA are serially input to the shift register 83 every 480 pixels that constitute one horizontal scanning line. Each time the serial load signal SRLD is input, the shift register 83 transfers the image data DATA about 480 pixels to a pulse-width modulation (PWM) portion 84 in parallel at times prescribed by the shift clock SHIFT CLK. The waveforms of the serial load signal SRLD, shift clock SHIFT CLK, and image data DATA are shown in FIGS. 7A, 7B, and 7C, respectively.

Note that the image data DATA is input to the drive circuit 80 after correction of a light quantity is performed in a deviation calculating portion 70. The light-quantity correction will be described later.

Each time the clock PWM CLK, synchronized with the line clock LINE CLK, is input, the PWM portion 84 outputs a voltage signal PWMₒᵤₜ of a pulse width corresponding to each of the image data about 480 pixels and inputs it to a positive-electrode driver 85. That is, if one of the image data DATA about 480 pixels, for example, the image data PWM DATA about the M^{th} pixel of one horizontal scanning line is as shown in FIG. 7D, the PWM portion 84 outputs a voltage signal PWMₒᵤₜ of a pulse width corresponding to that image data PWM DATA, as shown in FIG. 7E.

The positive-electrode driver 85 has a precharge switching portion 85a, a PWM switching portion 85b, and a power supply portion 85c, which are individually connected to each of 480 transparent positive electrodes 21. During the time the voltage signal PWMₒᵤₜ received by the PWM switching portion 85b is high, the transparent positive electrode 21 is connected to the power supply portion 85c. The drive waveform of the M^{th} transparent positive electrode 21 is shown in FIG. 7F. The drive current in the positive-electrode driver 85, and an off-state voltage in a negative-electrode driver 86 to be described later, are set according to a signal from a digital-to-analog converter (DAC) 82 for setting current and voltage.

On the other hand, the metal negative electrodes 23 are sequentially controlled every line by the negative-electrode driver 86. This negative-electrode driver 86 has switching portions 86a, which are connected to the three metal negative electrodes 23, respectively. The negative-electrode driver 86 is also connected with a line counter-decoder 87 to which the line clock LINE CLK and a line clear signal LINE CLR are input. During the time that a voltage signal LINE SEL, input from the line counter-decoder 87 to the switching portion 86a, is low, the metal negative electrode 23 is connected to ground so current can flow in a portion between the metal negative electrode 23 and the transparent positive electrode 21. The drive waveforms of the (N−1)^{st}, N^{th}, and (N+1)^{st} metal negative electrodes 23 at this time are shown in FIGS. 7G, 7H, and 7I, respectively. In this example, the N^{th} metal negative electrode 23 is being driven. And the waveform of the organic EL element 20 between the N^{th} metal negative electrode 23 and the M^{th} transparent positive electrode 21 is shown in FIG. 7J.

Note that in the example shown in FIG. 7, the N^{th} metal negative electrode 23 is driven at time T1 prescribed by the serial load signal SRLD, shown in FIG. 7A. And during the time the 480 transparent positive electrodes 21 that cross the N^{th} metal negative electrode 23 are being driven as shown in FIG. 7F, image data DATA are transferred in parallel from the shift register 83 to the PWM portion 84. The transferred image data DATA are used to drive the 480 transparent positive electrodes 21 that cross the (N+1)^{th} metal negative electrode 23.

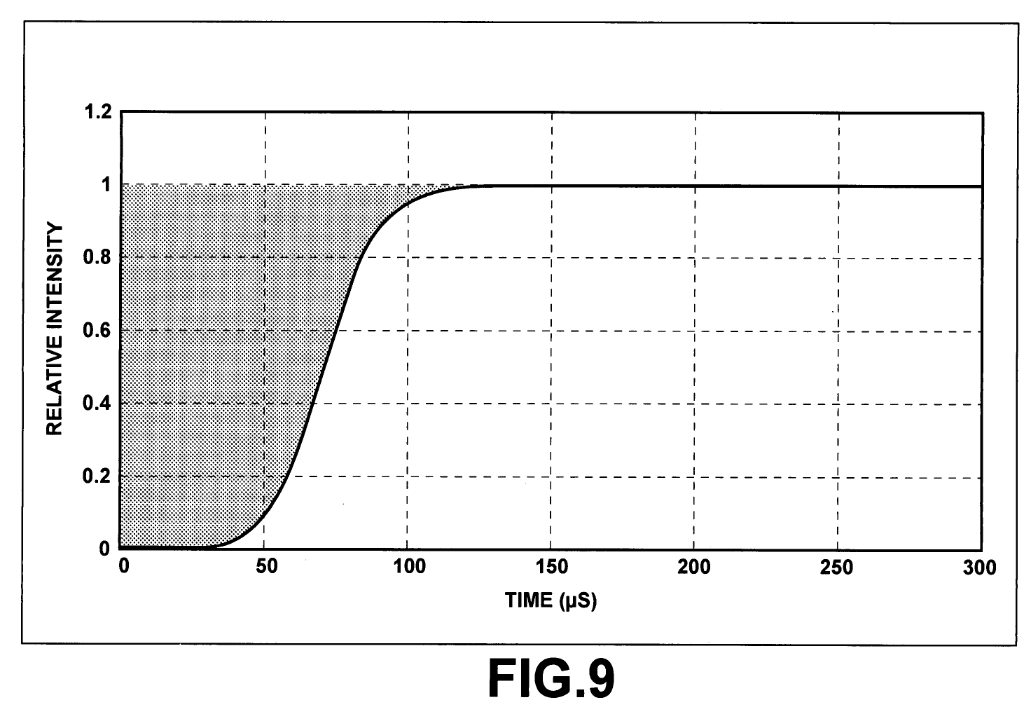

The light-emitting characteristic of the organic EL element 20 shown in FIG. 7J typically varies from element to element. Deviations in light-emitting characteristic are a deviation in light quantity due to a difference in intensity (indicated by reference character A in FIG. 7J) when the organic EL element 20 is on in a steady state, and a deviation in response characteristic (a deviation in a transient characteristic at startup time indicated by reference character B). These points will be described in detail with reference to FIG. 9, which shows the relationship between the light-emitting time and relative intensity in the case where one organic EL element 20 is continuously on. The light quantity of the organic EL element 20 is equal to the time integral of the intensity. Therefore, if the organic EL elements 20 differ in intensity, light-emitted quantities differ, even if the light-emitting times are the same. Also, an exposure that the color photosensitive material 40 undergoes actually is not merely (intensity×light-emitting time), but a quantity obtained by subtracting a shaded portion shown in FIG. 9 from (intensity×light-emitting time). And the transient characteristic shown in FIG. 9 typically varies from element to element.

If a deviation in light-emitted quantity or a deviation in response characteristic is present between organic EL elements 20, the color photosensitive material 40 undergoes different exposures when the organic EL elements 20 are driven according to the same image data DATA. Therefore, when such a difference in light-emitting characteristic is present between two adjacent organic EL elements 20, a difference in density occurs in a recorded image in the horizontal scanning direction. As a result, linear density unevenness (striped blurs) will extend in the vertical scanning direction.

The linear unevenness is prevented as follows:

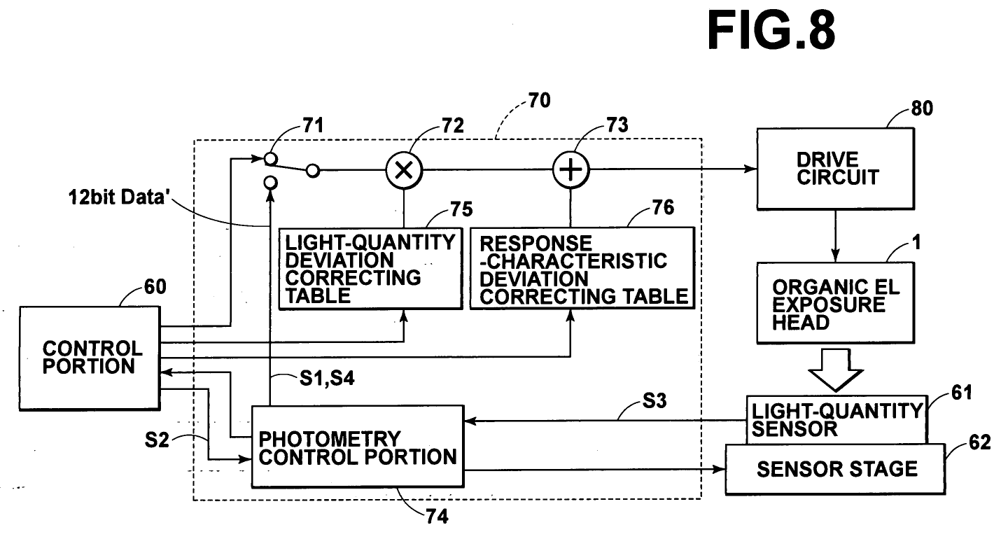

FIG. 8 shows an apparatus for carrying out a light-quantity correcting method that prevents the linear unevenness. This apparatus, in addition to the control portion 60 and deviation calculating portion 70 shown in FIG. 1, includes a light-quantity sensor 61 for measuring a light quantity emitted from each organic EL element 20 of the exposure head 1, and a sensor stage 62 for moving the light-quantity sensor 61 in the horizontal and vertical scanning directions. The deviation calculating portion 70 has an exposure/photometry switching portion 71, a multiplying portion 72, and an adding portion 73, which are provided between the control portion 60 and the drive circuit 80. The deviation calculating portion 70 further has a photometry control portion 74, a light-quantity deviation correcting table 75 connected to the multiplying portion 72, and a response-characteristic deviation correcting table 76 connected to the adding portion 73.

A description will hereinafter be given of how a light quantity is corrected. First, all the organic EL elements 20 of the exposure head 1 are caused to emit light for a predetermined time (which sufficiently exceeds response time) with the same driving condition. In this case, an EL-element drive signal S1 is output from the photometry control portion 74, and by disconnecting the exposure/photometry switching portion 71 from the data transmission path between the control portion 60 and the drive circuit 80 and connecting it to the photometry control portion 74, the EL-element drive signal S1 is supplied to the drive circuit 80. The intensity of the organic EL element 20 at this time is measured with the light-quantity sensor 61, and for all the organic EL elements 20, each intensity is measured by moving the light-quantity sensor 61 with the sensor stage 62.

The movement of the sensor stage 62 is controlled by the photometry control portion 74 that receives a control signal S2 from the control portion 60. A light-quantity measurement signal S3 from the light-quantity sensor 61 is input to the control portion 60 through the photometry control portion 74.

According to the light-quantity measurement signal S3 input from the light-quantity sensor 61, the control portion 60 calculates a correction coefficient for making the intensities of the organic EL elements 20 uniform, for each of the organic EL elements 20. More specifically, assuming the intensity of each organic EL element 20 is Eₙ (where n is an element number), a correction coefficient for each organic EL element 20 is determined as Eₘₐₓ/Eₙ, corresponding to a predetermined target value Eₘₐₓ. The control portion 60 causes the correction coefficients Eₘₐₓ/Eₙ to correspond to element numbers (i.e., pixel numbers), and they are stored in the deviation calculating portion 70 as the light-quantity deviation correcting table 75.

The photometry control portion 74 outputs an EL-element drive signal S4 for making the organic EL elements 20 of the exposure head 1 on uniformly and inputs the signal S4 to the drive circuit 80 through the exposure/photometry switching portion 71. This EL-element drive signal S4 is used to make each organic EL element 20 on in pulsed form for a period slightly longer than the response time (transient period) of the organic EL element 20 that is estimated to be slowest in response characteristic.

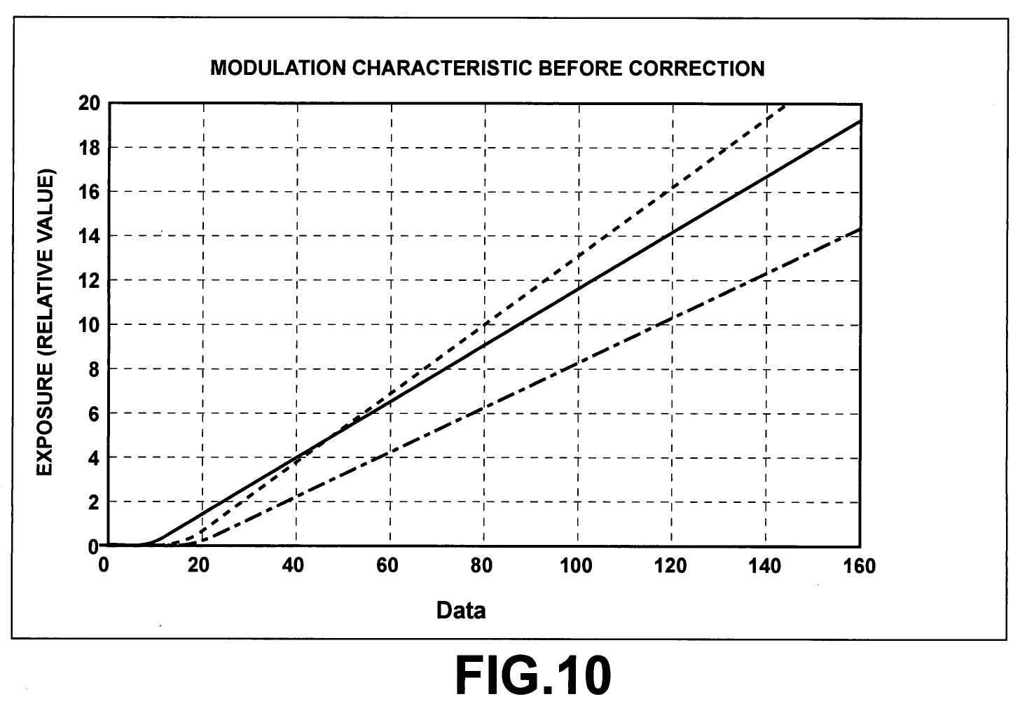

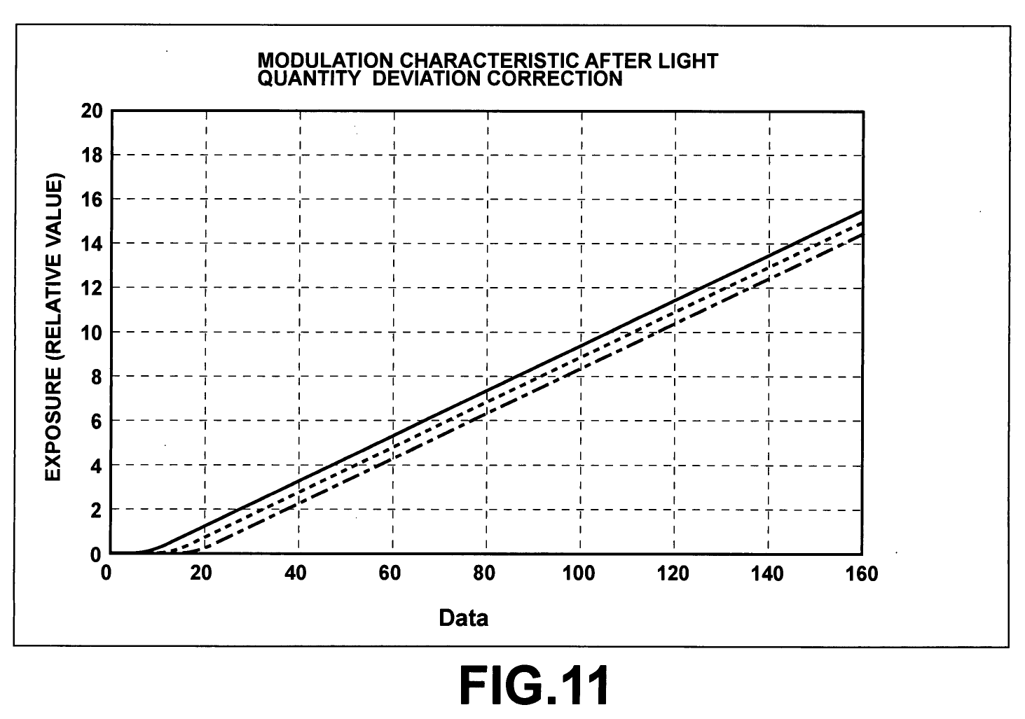

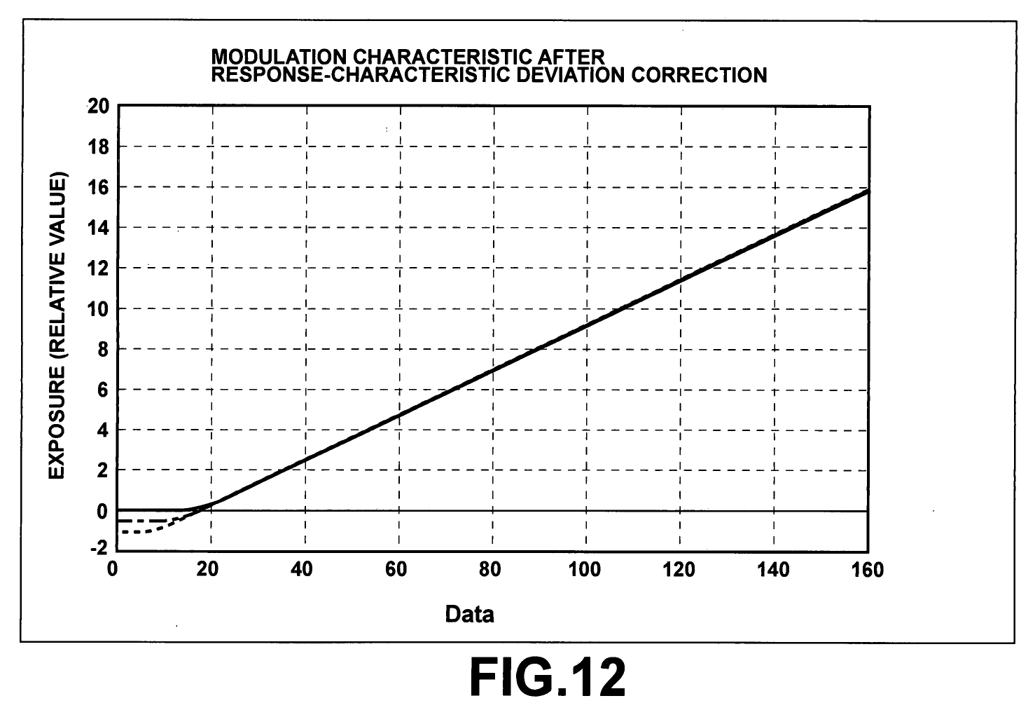

At the multiplying portion 72, the EL-element drive signal S4 is multiplied by the correction coefficient Eₘₐₓ/Eₙ stored in the light-quantity deviation correcting table 75. An exposure amount, exposed by each organic EL element 20 driven according to the EL-element drive signal S4 multiplied by the correction coefficient Eₘₐₓ/Eₙ, will be briefly described with reference to FIGS. 10 and 11. In this embodiment, exposures performed by three organic EL elements 20 will be described. In FIG. 10, the horizontal axis represents the value of data that causes the exposure time of the organic EL element 20 to change linearly according to the value of the EL-element drive signal S4, image data DATA, etc., while the vertical axis represents an exposure that the color photosensitive material 40 undergoes. The same applies to FIGS. 11 and 12.

Assume that when no correction is made, exposures performed by three organic EL elements 20 show different modulation characteristics, as shown in FIG. 10. And if these organic EL elements 20 are driven according to the EL-element drive signal S4 multiplied by the correction coefficient Eₘₐₓ/Eₙ, the modulation characteristics are as shown in FIG. 11. In this embodiment, if the EL-element drive signal S4 is multiplied by the correction coefficient Eₘₐₓ/Eₙ, the pulse width of light emitted from the organic EL element 20, which is one of the driving conditions, is corrected. However, the present invention is not limited to that correction. For example, by the multiplication of the correction coefficient Eₘₐₓ/Eₙ, the current or voltage for driving the organic EL elements 20 may be corrected. In the case of performing gradation transformation, the gradation transformation characteristic may be corrected.

When the organic EL element 20 is caused to emit light in pulsed form, the light intensity of that organic EL element 20 is measured with the light-quantity sensor 61. For all the elements 20 of the exposure head 1, measurements are made by moving the light-quantity sensor 61 with the sensor stage 62. At this time, the light-quantity measurement signal S3 output from the light-quantity sensor 61 is input to the control portion 60 through the photometry control portion 74.

According to the light-quantity measurement signal S3, the control portion 60 calculates a correction value for correcting the response characteristics of the organic EL elements 20, for each of the organic EL elements 20. More specifically, the time integral of the intensity of light emitted is calculated for each of the organic EL elements 20. And the differences (Sₘₐₓ−Sₙ) between the integrated value Sₘₐₓ of the organic EL element 20 where the integrated value is greatest among all elements 20 (i.e., where the response time is smallest) and the integrated value Sₙ of each organic EL element 20 (where n is an element number) are calculated. The calculated differences (Sₘₐₓ−Sₙ) are used as correction values. The control portion 60 causes the correction values (Sₘₐₓ−Sₙ) to correspond to element numbers (pixel addresses), and they are stored in the deviation calculating portion 70 as a response-characteristic deviation correcting table 76.

Note that if the time during which the organic EL element 20 is caused to emit light in pulsed form by the EL-element drive signal S4 is too long, the influence of a deviation in response characteristic on the time integral of the light intensity is relatively reduced. Therefore, the time during which the organic EL element 20 is caused to emit light is preferably a value close to the maximum response time of the organic EL element 20.

If the above-described steps are finished, the light-quantity sensor 61 and sensor stage 62 are disconnected from the exposure head 1, and the image recording apparatus 5 is actually used as described above. The steps of calculating the correction coefficients Eₘₐₓ/Eₙ and correction values (Sₘₐₓ−Sₙ) and storing them in the light-quantity deviation correcting table 75 and response-characteristic deviation correcting table 76 may be performed, for example, when shipping the image recording apparatus 5. Also, when the image recording apparatus 5 is actually being used by a user, the steps may be periodically performed once a day, a week, or a month. Furthermore, those steps may be performed each time the image recording apparatus 5 is switched on. Particularly, if the above-described steps are carried out as the image recording apparatus 5 is actually used, the apparatus 5 is able to cope with temporal changes in the light-emitting characteristics of each organic EL element 20.

When the image recording apparatus 5 is actually used, the exposure/photometry switching portion 71 shown in FIG. 8 is disconnected from the photometry control portion 74 and is connected to the control portion 60. At this time, the image data to be transferred from the control portion 60 to the drive circuit 80 is multiplied at the multiplying portion 72 by the correction coefficient Eₘₐₓ/Eₙ, and at the adding portion 73, the correction value (Sₘₐₓ−Sₙ) is added. In the preferred embodiment, the correction value (Sₘₐₓ−Sₙ) multiplied by a predetermined sensitivity coefficient α for the measuring system is particularly added. That is, assuming the image data sent out from the control portion 60 is Data′, the image data to be input to the drive circuit 80 is expressed by the following Equation:
Data=Data′×Eₘₐₓ/Eₙ+(Sₘₐₓ−Sₙ)×α

If a deviation in light quantity and a deviation in response characteristic are corrected as described above, a modulation characteristic at the time of recording an image is obtained as shown in FIG. 12. That is, since the correction of a deviation in response characteristic is performed on the characteristic shown in FIG. 11, the modulation characteristics of the organic EL elements 20 are made uniform over approximately the entire region where light is emitted. Therefore, even if there is a difference in light-emitting characteristics between adjacent organic EL elements, and they are driven according to the same image data (Data′), there is no difference in density in the horizontal scanning direction. Thus, the aforementioned linear unevenness can be reliably suppressed.

In the method according to the preferred embodiment, measurements are made only twice. That is, the two measurements are a measurement of a deviation in light quantity that is made with the organic EL elements 20 on in a steady state, and a measurement of a deviation in response characteristic that is made with the organic EL elements 20 on in pulsed form before they reach a steady state. Thus, the method of the preferred embodiment renders it possible to reduce the time and cost required for light-quantity correction.

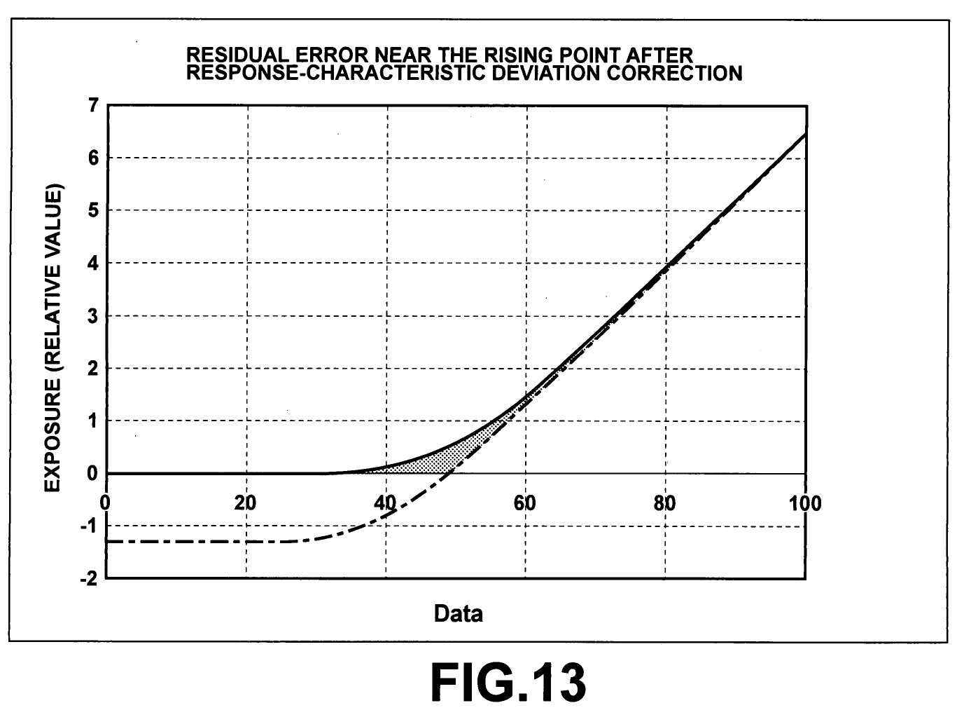

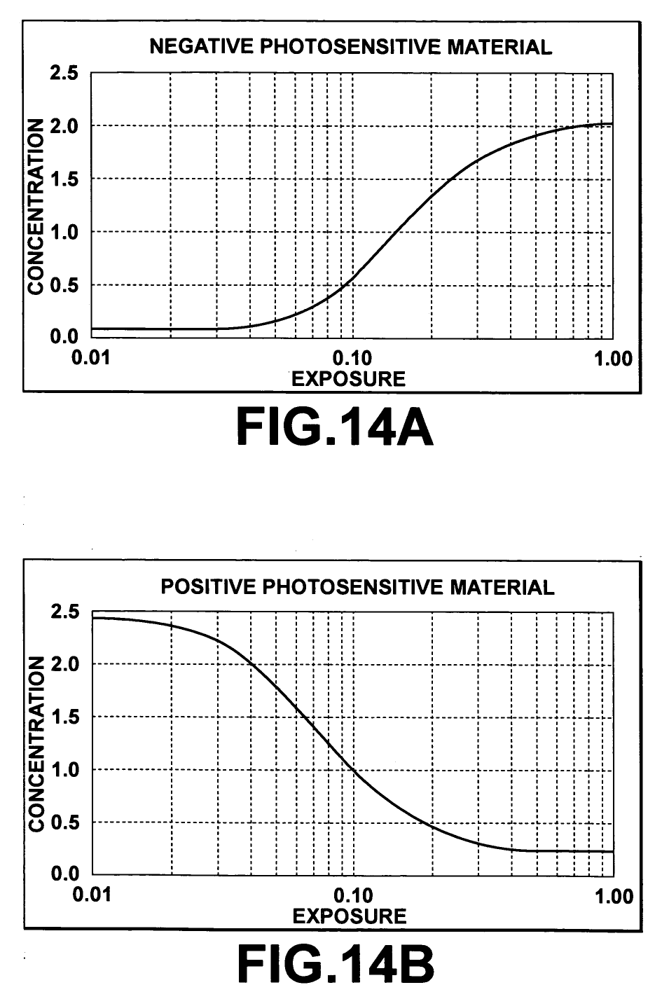

As shown in FIG. 13, which shows two of the characteristics of FIG. 12 on an enlarged scale, there is a slight difference in exposure (indicated by a shaded portion) near points where the modulation characteristic curves for the organic EL elements 20 rise. However, as shown in FIGS. 14A and 14B which show the sensitometric characteristics for negative and positive photosensitive materials, a change in density relative to a change in exposure is extremely small in a region where an exposure is slight. Therefore, there is no possibility that the above-described slight difference in exposure will cause visible linear unevenness.

While the image recording apparatus 5 employing organic EL elements 20 has been described, the present invention is also applicable to image recording apparatuses employing other light-emitting elements such as an LED array, inorganic EL elements, etc., and likewise possesses the aforementioned advantages.

Although it has been described that the exposure head 1 in the preferred embodiment exposes the photosensitive material 40 with red, green, blue light, a photosensitive material can be exposed with cyan, magenta, yellow light. In addition, the number of colors is not limited to three colors. In the case of a full-color image, it may be formed with four colors. In the case of an image not in full color, it may be formed with two colors. In the case of a monochromatic image, it may be formed with one color.

1. A light quantity correcting method for use in an image recording apparatus for recording a gradation image on a photosensitive material, comprising
a light-emitting element array in which a plurality of light-emitting elements are arranged in a horizontal scanning direction,
vertical scanning means for moving said light-emitting element array and said photosensitive material relatively in a vertical scanning direction approximately perpendicular to said horizontal scanning direction, and
drive means for controlling light-emitting time of each of said plurality of light-emitting elements according to image data representing said gradation image,
the light-quantity correcting method comprising the steps of:
calculating a deviation in light quantity between said light-emitting elements when said light-emitting elements are caused to emit light in a steady state;
calculating a deviation in response characteristic between said light-emitting elements when said light-emitting elements are caused to emit light in pulsed form before they reach said steady state, after said deviation in light quantity is corrected; and
correcting said deviation in light quantity and said deviation in response characteristic when recording said gradation image.

2. The light-quantity correcting method as set forth in claim 1, wherein said deviation in response characteristic is calculated according to an exposure amount, exposed by each of said light-emitting elements when said light-emitting elements are caused to emit light in pulsed form for a predetermined time close to response time of a light-emitting element of said light-emitting elements which is slowest in response time.

3. The light-quantity correcting method as set forth in claim 2, wherein said exposure is calculated by integrating the light intensity of each light-emitting element in light-emitting time.

4. The light-quantity correcting method as set forth in claim 1, wherein said deviation in light quantity is calculated according to light intensities of said plurality of light-emitting elements.

5. The light-quantity correcting method as set forth in claim 1, wherein said deviation in light quantity is corrected by multiplying at least either one of a drive voltage, drive current, or light-emitting time of each light-emitting element by a correction coefficient.

6. The light-quantity correcting method as set forth in claim 5, further comprising the step of storing said light-emitting element and said correction coefficient in a look-up table so that they correspond to each other;
wherein said multiplication is performed by employing said correction coefficient read out from said look-up table, for each of said light-emitting elements.

7. The light-quantity correcting method as set forth in claim 1, wherein said deviation in response characteristic is corrected by adding a correction value to at least either one of a drive voltage, drive current, or light-emitting time of each light-emitting element.

8. The light-quantity correcting method as set forth in claim 7, further the step of storing said light-emitting element and said correction value in a look-up table so that they correspond to each other;
wherein said addition is performed by employing said correction value read out from said look-up table, for each of said light-emitting elements.

9. An image recording apparatus for recording a gradation image on a photosensitive material, comprising:
a light-emitting element array in which a plurality of light-emitting elements are arranged in a horizontal scanning direction;
vertical scanning means for moving said light-emitting element array and said photosensitive material relatively in a vertical scanning direction approximately perpendicular to said horizontal scanning direction;
drive means for controlling light-emitting time of each of said plurality of light-emitting elements according to image data representing said gradation image;
light-quantity-deviation calculation means for calculating a deviation in light quantity between said light-emitting elements when said light-emitting elements are caused to emit light in a steady state;
response-deviation calculation means for calculating a deviation in response characteristic between said light-emitting elements when said light-emitting elements are caused to emit light in pulsed form before they reach said steady state, after said deviation in light quantity is corrected; and
correction means for correcting said deviation in light quantity and said deviation in response characteristic when recording said gradation image.

10. The image recording apparatus as set forth in claim 9, wherein said response-deviation calculation means calculates said deviation in response characteristic according to an exposure amount, exposed by each of said light-emitting elements when said light-emitting elements are caused to emit light in pulsed form for a predetermined time close to response time of a light-emitting element of said light-emitting elements which is slowest in response time.

11. The image recording apparatus as set forth in claim 10, further comprising means for calculating said exposure by integrating the light intensity of each light-emitting element in light-emitting time.

12. The image recording apparatus as set forth in claim 9, wherein said light-quantity-deviation calculation means calculates said deviation in light quantity according to light intensities of said plurality of light-emitting elements.

13. The image recording apparatus as set forth in claim 9, wherein said correction means corrects said deviation in light quantity by multiplying at least either one of a drive voltage, drive current, or light-emitting time of each light-emitting element by a correction coefficient.

14. The image recording apparatus as set forth in claim 13, further comprising a look-up table where said light-emitting element is caused to correspond to said correction coefficient;
wherein said correction means performs said multiplication by employing said correction coefficient read out from said look-up table, for each of said light-emitting elements.

15. The image recording apparatus as set forth in claim 9, wherein said correction means corrects said deviation in response characteristic by adding a correction value to at least either one of a drive voltage, drive current, or light-emitting time of each light-emitting element.

16. The image recording apparatus as set forth in claim 15, further comprising a look-up table where said light-emitting element is caused to correspond to said correction value;
wherein said correction means performs said addition by employing said correction value read out from said look-up table, for each of said light-emitting elements.
